(19) United States
(12) Patent Application Publication
(10) Pub. No.: US 2007/0223982 A1
(43) Pub. Date: Sep. 27, 2007

(54) Design and functional improvements for hand held printers

(75) Inventors: David D. Miller, Phoenix, AZ (US); Paul J. Lemens, Scottsdale, AZ (US)

Correspondence Address: PILLSBURY WINTHROP SHAW PITTMAN, LLP, P.O. BOX 10500, MCLEAN, VA, 22102, US

(73) Assignee: Xyron, Inc., Scottsdale, AZ (US)

(21) Appl. No.: 11/386,845

(22) Filed: Mar. 23, 2006

(51) Int. Cl. B41J 3/36

(52) U.S. Cl. 400/88

(57) ABSTRACT

A hand held printing device is disclosed that tracks its motion and prints an image based on its sensed position. The printing device includes a controller, a position sensor, a housing, a display, and a user interface. The display is pivotable between an open position, in which it uncovers the user interface, and a closed position in which the user interface is covered. The printing device further comprises a recessed bottom surface to prevent smearing of ink and an alignment mechanism that allows a user to precisely align a printed image. The alignment mechanism includes a reference indicator located on the housing in close proximity to a target surface and a correlating reference indicator located on the display.

### FIELD OF THE INVENTION

The present invention relates to hand-held printers and, more particularly, to design and functional improvements for hand-held printers that provide increased accuracy, image clarity, comfort, and/or component protection.

### BACKGROUND OF THE INVENTION

International Application Publication WO 03/076197 A1 to Dagborn, which is incorporated herein by reference, discloses a hand held printing device including a position sensor, a processor, electronic memory, and a print head. The processor is connected to a hardware control arrangement that includes programmable logic means connected to electronic memory. The controller receives an input from the position sensor and controls a printout from the print head by computing the received signals and image information.

U.S. Pat. No. 5,927,872 to Yamada, which is incorporated herein by reference, discloses a system and a method of printing an image represented by a frame of image data utilizing a hand held printer having optical sensor means for tracking positions of the hand held printer relative to the surface of a print medium during a printing process.

While the Dagborn and Yamada disclosures pertain to the technical features of a hand held printing device and those characteristics relating to the operation of such a device, they lack key practical functionality and design characteristics of a hand held printing device that is configured to print an image on a target surface in a linear or non-linear fashion. It is therefore an object of the present invention to address these concerns and to present an improved hand held printing device that has increased accuracy, image clarity, comfort, and/or component protection.

### SUMMARY OF THE INVENTION

The hand held printing device in accordance with the present invention comprises a housing and a print head for printing onto a target surface. The device further comprises a position sensor for sensing movement of the device relative to the target surface and a controller that is communicated to the print head and the position sensor. The controller is operable to track a movement of the device relative to the target surface based on movement sensed by the position sensor and to control the print head based on the tracked movement. The device also comprises a user interface having one or more user inputs being communicated to the controller and the user interface is mounted on an upper portion of the housing.

According to an aspect of the invention, a display is provided and is movably mounted to the housing for movement between (a) a closed position wherein the display covers the user interface and (b) an open position wherein the display uncovers the user interface and is viewable by a user.

According to another aspect of the invention, a display is provided on the housing, communicated to the controller, and is operable to display at least a portion of an image to be printed. The controller is operable during printing to output to the user an indication of progress of the image being printed.

According to a further aspect of the present invention, the housing includes a reference indicator that is positioned so as to be adjacent to the target surface prior to and during printing. The display includes a correlating reference indicator and the controller is operable to move the displayed image on the display relative to the correlating reference indicator based on a tracked movement of the device so that a relative position between the correlating reference indicator and the displayed image substantially corresponds to a relative position between the reference indicator on the housing and the image being printed.

According to another aspect of the invention, the housing includes a bottom surface for engaging the target surface and has a recessed portion separating a pair of engaging portions. The engaging portions are configured to engage the target surface during printing with the recessed portion spaced above the target surface. The recessed portion includes a print head opening through which the print head prints and extends to at least one lateral edge of the bottom surface. The print head opening is at an inner portion of the recessed portion and the recessed portion includes at least one wider portion extending inwardly from the lateral edge of the recessed portion to the inner portion and having a greater width than the inner portion.

According to another aspect of the invention, the housing includes a reference indicator positioned so as to be adjacent to the target surface prior to and during printing and is a predetermined distance from the print head. The controller is operable to delay printing of the image until the user has moved the device by essentially the predetermined distance.

A method of printing an image on a target surface using a hand-held printing device is also provided. The method includes moving the printing device relative to the target surface and operating a print head of the printing device to print an image on the target surface and outputting to the user an indication of progress of the image being printed.

Other objects, aspects, and advantages of the disclosure will become apparent from the following detailed description, the accompanying drawings, and the appended claims.

### BRIEF DESCRIPTION OF THE DRAWINGS

The above-mentioned and other features and advantages of this disclosure, and the manner of attaining them, will become more apparent and the disclosure itself will be better understood by reference to the following description taken in conjunction with the accompanying drawings, wherein:

FIG. 1 is a schematic perspective view of a hand held printing device in accordance with the present invention;

FIG. 2 is a schematic bottom view of a hand held printing device in accordance with the present invention;

FIG. 3 is a schematic side view of a hand held printing device in accordance with the present invention;

FIG. 4 is a cross-sectional view of the hand held printing device shown in FIG. 2, taken along line A-A′;

FIG. 5 is a schematic view of a display screen of the hand held printing device in accordance with the present invention; and

FIG. 6 is a schematic view of a display screen of the hand held printing device in accordance a further aspect of the present invention.

The invention will be described with reference to the accompanying drawings. Corresponding reference characters indicate corresponding parts throughout the several views. The description as set out herein illustrates an arrangement of an embodiment of the present invention and is not to be construed as limiting the scope of the disclosure in any manner.

### DETAILED DESCRIPTION OF THE INVENTION

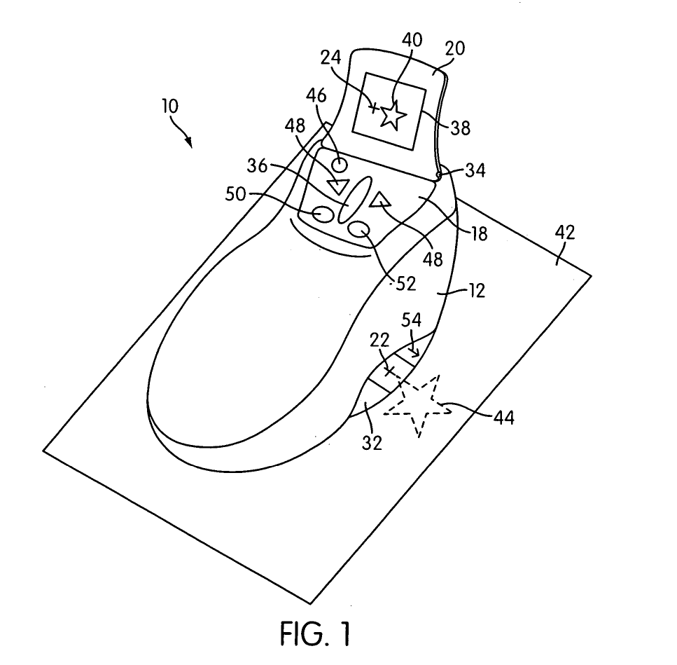

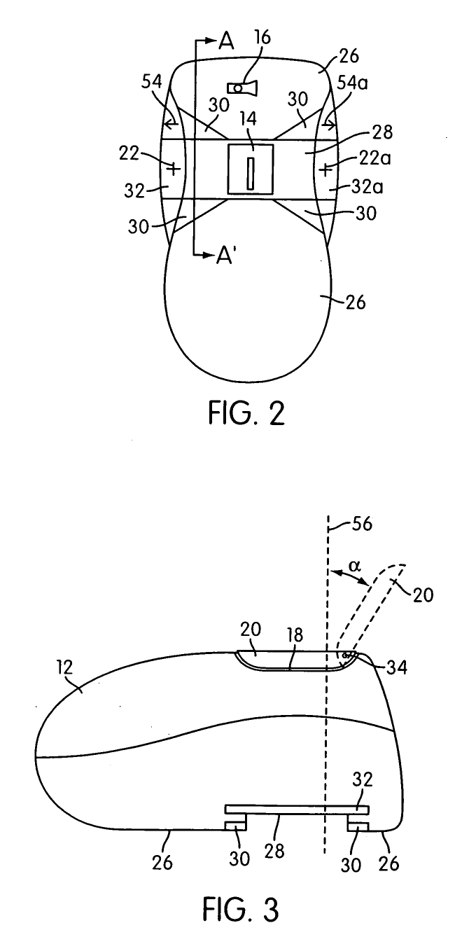

Referring to FIG. 1, a hand held printer 10 is shown placed over a target surface 42 upon which an image 44 will be printed. The image to be printed 44 is shown in dashed lines so as to represent the location on the target surface 42 at which the image will be printed; it has not yet been printed. To print a selected image 40, a user aligns the printer 10 relative to a location on the target surface 42 at which the user desires the image 40 to be printed, inputs a command to the printer 10 to begin printing, and then slides the printer 10 along the target surface 42 as a print head 14 (see FIG. 2) on the underside of the housing 12 automatically prints the image 40 based on a sensed movement of the printer 10 on the target surface. A processor within the printer housing 12 controls the output of the print head 14 based on the sensed location and/or movement of the printer 10. The position of the hand held printer 10 is sensed by a position sensor 16 located on the bottom surface 26 of the printer 10. The position sensor 16 may be a sensor known in the art and may comprise an LED-based optical sensor, wheeled or ball sensor, or any other suitable position sensor (and multiple sensors may be used if desired). Further details and various features of the present invention will become evident by the following detailed description.

The term print head is used to describe any element that deposits or transfers ink or toner, or any other substance onto a surface. The print head may be an ink jet head or any other suitable printing element. The various aspects of the invention are not limited to any specific type of printing. Also, the term controller is used to broadly refer to the general control system of the device 10 and any various sub-components thereof. The controller functionality may be embodied in a single integrated processor that receives and transmits signals to and from the various functional components (e.g., the display, the print head, the user interface, the position sensor, and the memory). It may also be embodied in discrete components. For example, the display may have its own driver and other functional elements may connect directly to a processor. The display driver would still be regarded as part of the overall controller, as it provides the functionality to control the display. The controller need not use a microprocessor, any suitable architecture for the controller is envisioned.

The printer 10 includes a housing 12 that encloses and protects the internal hardware and circuitry. The internal workings of the device are known in the art and include a position sensor 16, a print head 14, a processor or controller, and electronic memory, as disclosed in the above-incorporated International Application Publication Number WO 03/076197 A1. The memory may be integrated into the device 10, and thus images for printing may be uploaded by a USB (universal serial bus) cable or any other wired or wireless connection from another device, such as a personal computer. Likewise, the memory may be removable, such as a flash card or other removable memory media.

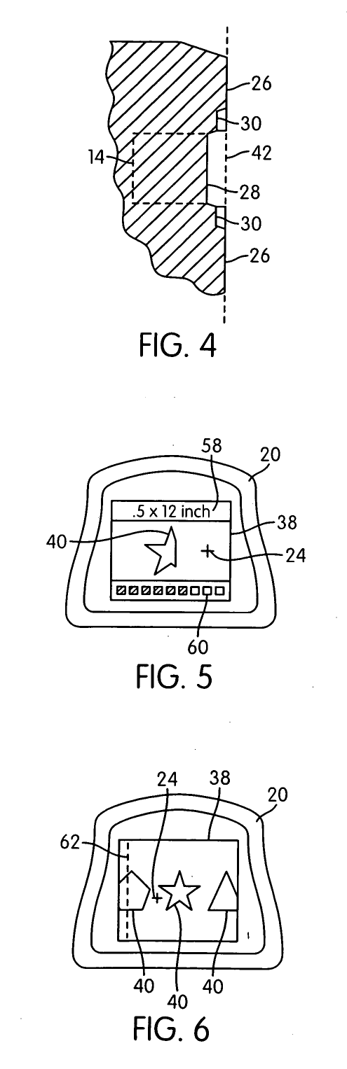

The housing 12 may be designed of sufficient size and shape so as to follow the contours of a user's hand in operation. An example of such a shape is shown in the Figures and includes a bulbous rear portion and a concave front portion to enhance comfort and grip. The housing 12 has a bottom surface 26 that has defined therein a recessed surface 28. The bottom surface 26 engages the target surface 42 at least at two locations, one on either side of the recessed surface 28, as shown in FIGS. 2 and 4. The recessed surface 28 is to prevent smearing of ink by the bottom surface 26 of the printer housing 12 after the ink has been emitted from the print head 14. The present invention further provides that the recessed surface 28 includes flared portions 30, discussed below, that further limit the presence of an interfering bottom surface 26 to allow a user to print along curves or varying non-linear paths without smearing ink. The bottom surface 26 may optionally include rollers or other such structures to facilitate smooth travel of the device over the target surface.

The hand held printer 10 includes a user interface 18. The user interface may contain various buttons, knobs, or other input devices to enable a user to supply commands or instructions to the printer 10. The print button 36, for example, may instruct the printer to begin printing or to continue printing. The user interface may also include a power button 46, left and right selection or scrolling buttons 48, an image effect button 50, or an options button 52. The user interface 18 may comprise individual buttons or preferably a membrane button pad. A membrane button pad may provide a seal that reduces openings into the housing, thereby preventing contamination or buildup of dust. The membrane button pad may further include raised button regions with tactile features, such as a concave surface, so that a user may operate the printer 10 without looking at the user interface 18.

The power button 46 may simply be used to turn the printer on and off or to reset the device (e.g., if the button 46 is held for a certain amount of time, such as 2 seconds, it will reset the system).

Left and right selection or scrolling buttons 48 may be used to scroll through various images that are recorded in electronic memory in order to select the image a user wants to print. Once an image is selected, a user can use the left and right selection buttons 48 to identify a specific location on the image, as viewed on a display 20, that is desired to be correlated with a location on the target surface 42, as discussed below.

Image effect button 50 may be used to select from among various effects that the hand held printer 10 is capable of performing, such as printing the selected image 40 in a repeating (continuous) manner, inverting the image vertically, horizontally, or about a specified axis, or rotating the image by a specified degree. In a repeating mode, a specific number of images 40 to be printed may be chosen prior to printing. In a continuous mode, the printer 10 may continue to print the image 40 repeatedly until the user releases the print button 36 (or otherwise commands the printer 10 to stop printing). The image effect button 50 may also be programmed to adjust the overall size or the particular dimensions of the printed image. While the image effect button 50 has so far been described as comprising a single button, the present invention contemplates that any number of buttons may be used and programmed to allow the user to input various effects. Each button may be programmed to be associated with a particular effect or one button may be programmed to be associated with several effects, optionally utilizing a graphical menu displayed on the screen 38 to aid in providing visual feedback to the user regarding the available effects.

Options button 52 may be utilized to present a variety of preference choices to the user in order to make adjustments to the way in which the hand held printer operates. One option may be to command the print head 14 to output ink from all of its nozzles for routine maintenance purposes.

As shown in FIG. 1, the hand held printer includes a display 20 having at least one digital image display screen 38, such as a liquid crystal display (LCD). The display 20 provides visual output of the activities of the printer 10 and enables a user to interact with the printer 10 during various phases of operation. For example, the display 20 may display the various images in a bank recorded in electronic memory, changing the image displayed as the user scrolls through the bank, so that a user may preview an image prior to selection. The display 20 may also display the various menus of effects and options available when a user chooses to perform those functions. In addition, the display 20 may display the image 40 selected to be printed while the hand held printer 10 prints the image 40.

In a preferred embodiment, the display may also display a real-time graphical representation of the print status or progress. As shown in FIG. 5, a real time graphical representation of the print status of the image 40 is displayed. The display may provide such information as the dimensions 58 of the printed image, a progress bar 60, or the portion of the image 40 that has so far been printed.

The display 20 may be configured to pivot from an open position to a closed position. In the open position, as shown in FIG. 1, the display is oriented at an angle so that it is easily viewed by a user and the user interface 18 is uncovered. In the closed position, as shown in FIG. 3, the display 20 covers the user interface 18 and minimizes the size of the device for storage. When the display is in the closed position, it protects the user interface from dust or impact. As is shown in FIG. 3, when the display 20 is in the open position (indicated by dashed lines), it may be positioned at an angle α in the range of about 10 to 80 degrees measured from an axis 56 extending orthogonally from a bottom surface 26 of the hand held printer 10. The display 20 may pivot about a hinge 34, which may be of any known hinge type and may include a biasing element or a dual biasing element so that it may urge the display 20 to the closed position, the open position, or both. The hinge 34 may alternatively comprise a position holding element so that a user may position the display 20 at any desired angle α and allow the position holding element to hold it at that angle α to provide the most comfort to the user.

The display 20 may include a correlating reference indicator 24 that correlates a location on the target surface 42 with a location on the electronic display of the image 40 to be printed, as discussed below. This correlation or alignment is advantageous because the print head 14 (and likewise the portion of the target surface 42 immediately beneath the print head 14) is not visible while printing takes place. Without an alignment mechanism, a user may have difficulty accurately predicting the point at which the print head 14 will begin printing unless he or she has substantial experience with the device.

A location on the target surface 42 is correlated to the image 40 on the display so that a user may accurately align an image to be printed. The location at which an image is desired to be printed is indicated by dashed lines 44 in FIG. 1. To provide for alignment of the printed image, a reference indicator 22 is provided close to the bottom surface 26 of the housing 12. Reference indicator 22 may be a pair of crosshairs or any other visual indicia capable of locating or being aligned with a specific point on the target surface 42, including any edge, contour or structure on or attached to the housing 12.

The housing 12 may include a transparent guide 32, 32a on each side of the housing upon which the reference indicator 22, 22a is etched, embedded, or otherwise marked. Directional arrows 54, 54a may likewise be marked on the transparent guides 32, 32a. Directional arrows 54, 54a may provide additional guidance to the user by indicating the direction of movement of the device 10 that is applicable to the reference indicator 22, 22a that is on the same guide 32, 32a. For instance, the right directional arrow 54 that is on the same guide 32 as the reference indicator 22 informs the user that the reference indicator 22 applies when the device 10 is moved to the right. Likewise, the left directional arrow 54a that is on the same guide 32a as the reference indicator 22a informs the user that the reference indicator 22a applies when the device 10 is moved to the left.

The correlating reference indicator 24 is provided on the display 20. The correlating reference indicator 24 may be either physically formed on the display screen 38, by etching or some other marking technique, or transiently displayed on the screen 38 by electronic means (i.e., displayed under operation of the controller). When a displayed image 40 is selected to be printed from among a bank of images, it is displayed on the display 20 along with the correlating reference indicator 24, thereby establishing a first reference point relative to the displayed image 40.

To print the image 40 on the target surface 42 at a particular location 44, the hand held printer 10 is first placed upon the target surface 42 in the general vicinity of the location 44 at which the image is desired to be printed, as shown in FIG. 1. In the embodiment shown in FIG. 1, the hand held printer 10 is placed to the left of the location 44 at which the image is to be printed. The user then aligns the reference indicator 22 at a location on the target surface 42, relative to the location 44 at which the image is to be printed. The spatial relationship between the reference indicator 22 (and the point beneath it on the target surface 42) and the print head 14 corresponds to the relative position of the correlating reference indicator 24 with respect to the displayed image 40 on the display screen 38. For example, as shown in FIG. 1, the correlating reference indicator 24 is positioned at the left-most portion of the displayed image 40. Accordingly, the user places the hand held printer 10 on the target surface 42 such that the reference indicator 22 is at the left-most portion of the location 44 at which the image is to be printed. In other words, the printer 10 is positioned on the target surface such that the reference indicator 22 is at the position at which the printer 10 will begin to print the image 40 at the location 44 as it moves from left to right. This is desirable for situations where the user wants the printed image to start at a specific location on the target surface 42.

Alternatively, the hand held printer may be placed to the right of a location on the target surface at which an image is desired to be printer. If the printer 10 is positioned to the right side of a location at which the image 40 is desired to be printed, the correlating reference indicator 24 may be displayed on the right-most portion of the image 40 on the display 20, a further reference indicator 22a (as shown in FIG. 2) is provided on the left-hand side of the housing 12, and the processor is configured to recognize, upon initial movement of the printer 10, that it is moving from right to left instead of left to right such that the print head 14 will be commanded to print the image 40 from right to left accordingly.

To print the image 40, the user then presses the print button 36 and slides the printer 10 toward and past the location 44 at which the image is desired to be printed. The position sensor 16, in communication with a processor, allows the controller to track the position of the printer 10 on the target surface 42 and to instruct the print head 14 to eject ink at an appropriate time and rate such that an image is printed uniformly, essentially regardless of how fast the user moves the printer 10 and regardless of its path. In some embodiments, if the user moves the device faster than the print head can print, then some distortion of the image may occur. This may be desirable, however, for creating certain effects, such as an elongated version of the image.

In an embodiment where the correlating reference indicator 24 is located at the left-side beginning (i.e., the left edge) of a displayed image 40, the print head 14 will begin printing as it passes over the location where the user had aligned the reference indicator 22.

Because the distance between the reference indicator 22 and the print head 14 is known, the controller can delay printing of the image until the controller detects via the position sensor 16 that the user has moved the device 10 by that known distance. Thereafter, the printing of the image can continue in a typical fashion.

The display 20 may optionally provide additional guidance as to the location/progress of the printed image while it is being printed. As shown in FIG. 5, the display 20 reports the progress of the printer by displaying the portion of the image 40 that has so far been printed. The display in FIG. 5 also shows the relation between the image that is currently being printed 40 and the correlating reference indicator 24, which corresponds to the relation between the actual printed image on the target surface 42 and the reference indicator 22. This information can be helpful to the user in planning the path of the printed image during printing.

Alternatively, the display 20 can display the image or images 40 in a scrolling manner and in relation to the correlating reference indicator 24 so that a user may plan the location of the image or images 40 as they come across the display 20, as shown in FIG. 6. In this case, the processor moves the image 40 or string of images 40 across the display 20 and in relation to the correlating reference indicator 24 so that the user can use that information to position the reference indicator 22 on the target surface 42 accordingly. The image 40 is moved across the display 20 based on the tracked position of the printing device 10. The images 40 appearing on the display 20 at a particular moment will be printed on the target surface 42 in such a way that the current relation between the images 40 and the correlating reference indicator 24 corresponds to the current location of the reference indicator 22 and the future location 44 of the actual printed image.

It is noted that displaying the image relative to the correlating indicator 24 as discussed above does not necessarily indicate the real-time progress of the printer 10 as it is printing the image 40, as was the case with the embodiment depicted in FIG. 5. This is because the reference indicator 24 is correlated to indicator 22, which is ahead of the print head 14 in the direction of movement. For this purpose, however, another reference indicator can be provided on the display to identify the current real-time location of the print head 14 so that print progress can be monitored (for ease of distinguishing this indicator from indicator 24, this may be referred to as a real-time reference indicator). For example, as shown in FIG. 6, the processor can be configured, and the display calibrated, so that the left edge of the screen 38 represents the current location of the print head 14. That is, the displayed image 40 would be moved relative to the left edge during printing so that a relative position between the edge and the displayed image 40 substantially corresponds to a relative position between the print head 14 and the image being printed. Alternatively, a vertical line 62 or some other visual indicia may be transiently displayed on the screen 38 relative to the displayed image 40 to represent the current location of the print head 14 relative to the printed image. Likewise, a visual indicia such as the line 62 may be formed or etched on the display screen 20 itself and the displayed image 40 may be moved relative to the line 62 to provide the same representation of the current location of the print head 14 relative to the image being printed.

Additionally, the aspect of displaying the progress of the image being printed may be adapted to variations where the image to be printed has substantial horizontal and vertical components, such as a 4 inch by 6 inch picture (i.e., a two-dimensional image). In such an embodiment, instead of correlating between a left or right edge of a substantially linear image (also called banner style), the correlation may be between a corner of the image, any other appropriate point along its edge, or its center. As such, any modification embodying such capability to correlate a reference indicator 22 with the displayed image and/or to displaying progress of image printing is within the scope of the invention.

In any of the above-described display configurations, a further way of showing real-time progress may be an indication that alerts the user when the printer 10 has completed the printing of an image. For example, if the printer is in continuous mode, such an indication may be for the image 40 displayed on the screen 20 to flash on and off after the printer 10 has completed each image (i.e., each iteration of the image being repeated) so that the printing of partial images is avoided. Any device of indication may be used to alert the user that an image has been completed, such as displaying a mark or symbol on the screen 20, or using a small speaker to generate an auditory tone (e.g., a beep) when an image is complete, etc.

With regard to any of the above-described display configurations, the present invention contemplates that the processor or controller of the hand held printing device 10 may be programmed to accommodate any of the display configurations and to allow the user to select a preferred display configuration at a time of their choosing. The choice of display configuration is preferably provided to the user via the options button 52 and associated menus, as described above.

The bottom surface 26 of the housing 12 may be designed to allow a user to print images without smearing ink. A recessed portion 28 extends to at least one lateral edge of the bottom surface 26 of the printer 10 so that the two portions of the bottom surface 26 on either side of the recessed portion 28 do not interfere with the print path and smear ink as the printer 10 is moved across a target surface 42. The recessed portion 28 includes a print head opening at an inner portion and may extend from the inner portion to one or both lateral edges of the bottom surface 26 or housing 12. By extending from the inner portion to both opposing lateral edges the printer 10 is capable of printing from left to right, right to left, or both, without smearing.

When a user desires to print in a non-linear or varying path (i.e., to create a curving or wavy effect), wider portions in the form of flares 30 are provided. These wider portions or flares 30 allow the device to be moved along sharper contours or angles without having the newly deposited ink contacted by the bottom surface 26. Flares 30 may be recessed to the depth equal to that of the area of the recessed portion 28 where the print head 14 is located, or flares 30 may be only slightly recessed so that they provide just enough clearance so that no surfaces come into contact with the ink applied to the target surface 42, as shown in FIGS. 2-4. FIG. 4 is a cross-sectional view of FIG. 2, taken along line A-A′, showing recessed portion 28 and flares 30 in relation to the bottom surface 26 when the flares 30 are recessed to about half of the depth of the inner portion of the recessed portion 28. As shown, the flares 30 are essentially portions of the recessed portion 28 that extend inwardly from the lateral edge of the recessed portion 28 to the inner portion of the recessed portion 28 and have a greater width than the inner portion. The recessed portion 28 may extend the entire lateral width of the housing 12 between opposing lateral edges and may include a pair of wider portions, or flares 30, extending inwardly from each lateral edge to the inner portion of the recessed portion 28.

The flares 30 may be angled from the horizontal printing axis, for example at an angle of about 45 degrees, to accommodate a wide range of possible non-linear movement of the printing device 10. The flares 30 and the recessed surface 28 may be shaped generally as an hourglass in the bottom surface 26 of the housing, as shown in FIG. 2, to reduce the possibility of interference with newly applied ink. The 45 degree angle is not critical, and the angles could vary. For example, angles between 30 to 60 degrees, or 40 to 50 degrees may be acceptable. These ranges are not limiting and other angles may be used. Also, other configurations for the wider outer portions(s) of the recessed portion 28 may be used. For example, instead of having edges that diverge at 45 degrees (or some other angle), the wider portion(s) may have edges that are parallel, but spaced wider than at the inner portion.

The disclosed printer 10 may have a wide variety of applications, including but not limited to crafting/scrap-booking, industrial uses, packaging, office use, file marking, etc.

While specific embodiments have been described above, it will be appreciated that the subject of the present disclosure may be practiced otherwise than as described. The descriptions above are intended to be illustrative, not limiting. Thus, it will be apparent to one skilled in the art that modifications may be made without departing from the scope of the claims set out below.

What is claimed is:

1. A hand-held printing device comprising:
a housing;
a print head for printing onto a target surface;
a position sensor for sensing movement of the device relative to the target surface;
a controller communicated to the print head and the position sensor, the controller being operable to track a movement of the device relative to the target surface using the position sensor and to control the print head based on the tracked movement;
a user interface having one or more user inputs communicated to the controller, the user interface being mounted on an upper portion of the housing; and
a display movably mounted to the housing for movement between (a) a closed position wherein the display covers the user interface and (b) an open position wherein the display uncovers the user interface and is viewable by a user.

2. The printing device of claim 1, wherein the display pivots between the open and closed positions.

3. The printing device of claim 1, wherein, when the display is in the open position, the display is at an angle with respect to an axis extending orthogonally with respect to a bottom surface of the housing.

4. A hand-held printing device comprising:
a housing;
a print head for printing onto a target surface;
a position sensor for sensing movement of the device relative to the target surface;
a controller communicated to the print head and the position sensor, the controller being operable to track a movement of the device relative to the target surface using the position sensor and to control the print head based on the tracked movement;
a display provided on the housing and communicated to the controller, the display being operable to display at least a portion of an image to be printed;
the controller being operable during printing to output to the user an indication of progress of the image being printed.

5. The printing device of claim 4, wherein the controller is operable during printing to output to the user the indication of the progress of the image being printed by displaying, on the display screen, a graphical representation of the progress of the image being printed.

6. The printing device of claim 5, wherein a speaker is coupled to the controller, and wherein the controller is operable during printing to output to the user the indication of the progress of the image being printed by emitting an auditory noise with the speaker upon completing printing of the image.

7. The printing device of claim 5, wherein the housing includes a reference indicator positioned so as to be adjacent the target surface prior to and during printing, and wherein the display includes a correlating reference indicator;
the controller being operable to move the displayed image on the display relative to the correlating reference indicator based on the tracked movement of the device so that a relative position between the correlating reference indicator and the displayed image substantially corresponds to a relative position between the reference indicator on the housing and the image being printed.

8. The printing device of claim 5, wherein the controller is operable to display the printing progress by displaying only the portion of the image that has been printed on the display.

9. The printing device of claim 5, wherein the controller is operable to display the printing progress by moving the displayed image on the display relative to a reference indicator on the display based on the tracked movement of the device so that a relative position between the reference indicator and the displayed image substantially corresponds to a relative position between the print head and the image being printed.

10. The printing device of claim 7, wherein the correlating reference indicator is selected from the group consisting of (a) an indicator provided on a transparent member covering the display and (b) an indicator transiently displayed on the display.

11. The printing device of claim 7, wherein the reference indicator is located on a side of the hand-held printing device close to the printing surface.

12. The printing device of claim 7, wherein the reference indicator is a set of crosshairs on a transparent member located on the hand-held printing device close to the printing surface.

13. The printing device of claim 7, wherein the correlating reference indicator is a set of crosshairs.

14. The printing device of claim 12, wherein the correlating reference indicator is a set of crosshairs.

15. The printing device of claim 4, further comprising a user interface, the user interface being operable to enable the user to instruct the controller to operate in repeating mode wherein the controller causes the print head to print the image in a repeating manner based on the tracked movement;
wherein the controller is operable during printing in the repeating mode to output to the user the indication of the progress of the image being printed by outputting an audio or visual signal upon the completion of each image being printed.

16. A hand-held printing device comprising:
a housing;
a print head for printing onto a target surface;
a position sensor for sensing movement of the device relative to the target surface;
a controller communicated to the print head and the position sensor, the controller being operable to track movement of the device relative to the target surface using the position sensor and to control the print head based on the tracked movement;
the housing including a bottom surface for engaging the target surface, the bottom surface having a recessed portion separating a pair of engaging portions, the engaging portions being configured to engage the target surface during printing with the recessed portion spaced above the target surface, the recessed portion including a print head opening through which the print head prints;
wherein the recessed portion extends to at least one lateral edge of the bottom surface and the print head opening is at an inner portion of the recessed portion, and wherein the recessed portion includes at least one wider portion extending inwardly from the lateral edge of the recessed portion to the inner portion, the wider portion having a greater width than the inner portion.

17. The printing device of claim 16, wherein the recessed portion extends an entire lateral width of the housing between opposing lateral edges, and wherein the recessed portion includes a pair of said wider portions each extending inwardly from a respective lateral edge to the inner portion.

18. The printing device of claim 17, wherein the recessed portion is shaped generally as an hourglass.

19. The printing device of claim 17, wherein the wider end portions are flared.

20. The printing device of claim 18, wherein each side of each wider end portion is flared about 45 degrees relative to a lateral axis of the recessed portion.

21. A method of printing an image on a target surface using a hand-held printing device, the method comprising:
moving the printing device relative to the target surface and operating a print head of the printing device to print an image on the target surface; and
outputting to the user an indication of progress of the image being printed.

22. A hand-held printing device comprising:
a housing;
a print head for printing onto a target surface;
a position sensor for sensing movement of the device relative to the target surface;
a controller communicated to the print head and the position sensor, the controller being operable to track a movement of the device relative to the target surface using the position sensor and to control the print head based on the tracked movement;
the housing including a reference indicator positioned so as to be adjacent the target surface prior to and during printing, the reference indicator being a predetermined distance from the print head;
wherein the controller is operable to delay printing of the image until the user has moved the device by essentially the predetermined distance.

23. The printing device of claim 22, further comprising a display provided on the housing and communicated to the controller, the display being operable to display at least a portion of an image to be printed;
wherein the display includes a correlating reference indicator;
wherein the correlating reference indicator is positioned at a beginning or peripheral edge of the displayed image.

24. The printing device of claim 23, wherein the correlating reference indicator is selected from the group consisting of (a) an indicator provided on a transparent member covering the display and (b) an indicator transiently displayed on the display.

25. The printing device of claim 23, wherein the reference indicator is located on a side of the hand-held printing device close to the printing surface.

26. The printing device of claim 23, wherein the reference indicator is a set of crosshairs on a transparent member located on the hand-held printing device close to the printing surface.

27. The printing device of claim 23, wherein the correlating reference indicator is a set of crosshairs.

28. The printing device of claim 26, wherein the correlating reference indicator is a set of crosshairs.
